(19) United States
(12) Patent Application Publication
(10) Pub. No.: US 2013/0312421 A1
(43) Pub. Date: Nov. 28, 2013

(54) FUEL CONTROL SYSTEM FOR A GAS TURBINE ENGINE

(71) Applicants: Gregory Palczewski, San Diego, CA (US); Roy Thomas Collins, San Diego, CA (US); Jim R. Waddell, Bonita, CA (US)

(72) Inventors: Gregory Palczewski, San Diego, CA (US); Roy Thomas Collins, San Diego, CA (US); Jim R. Waddell, Bonita, CA (US)

(73) Assignee: Solar Turbines Incorporated

(21) Appl. No.: 13/479,349

(22) Filed: May 24, 2012

(51) Int. Cl. F02C 9/26; G01F 7/00

(52) U.S. Cl. 60/772; 60/39.281; 73/195

(57) ABSTRACT

A fuel valve for a gas turbine engine includes a passageway configured to direct a fuel to the engine and a flow restriction positioned in the passageway. The fuel valve may also include a first pressure sensor coupled to the passageway upstream of the restriction through an upstream port, and a second pressure sensor coupled to the passageway downstream of the restriction through a downstream port. The fuel valve may further include a third pressure sensor coupled to the upstream port through a first branch port, and a fourth pressure sensor coupled to the downstream port through a second branch port.

### TECHNICAL FIELD

The present disclosure relates generally to fuel control system for a gas turbine engine, and particularly to fuel valve with backup flow measurement capability.

### BACKGROUND

In a typical gas turbine engine, fuel is combusted in a combustion chamber (called combustor) to produce high pressure combustion gases. These high pressure gases are then used to spin the rotors of a turbine to produce power. Various types of fuel, such as natural gas or diesel fuel, may be combusted in a gas turbine engine to produce power. To control the amount of power produced by the turbine engine, the quantity of fuel directed to the gas turbine engine is controlled. For efficient operation of the turbine engine it is desirable to know the amount of fuel directed to the turbine engine at any time. Methods of determining fuel flow to a gas turbine engine are known in the art. For example, U.S. Pat. No. 7,069,137 describes an exemplary fuel flow measurement method for a gas turbine engine. The method of the '137 patent includes using a variable flow metering device including a plurality of sensors to determine the fuel flow to the turbine engine.

### SUMMARY

In one aspect, a fuel valve for a gas turbine engine is disclosed. The fuel valve includes a passageway configured to direct a fuel to the engine and a flow restriction positioned in the passageway. The fuel valve may also include a first pressure sensor coupled to the passageway upstream of the restriction through an upstream port, and a second pressure sensor coupled to the passageway downstream of the restriction through a downstream port. The fuel valve may further include a third pressure sensor coupled to the upstream port through a first branch port, and a fourth pressure sensor coupled to the downstream port through a second branch port.

In another aspect, a method of measuring a quantity of fuel flowing to a gas turbine engine is disclosed. The method includes directing the fuel to the engine through a flow restriction positioned in a passageway and measuring the quantity of fuel flowing through the passageway based on measurements of a first pressure sensor and a second pressure sensor. The first pressure sensor may be coupled to the passageway upstream of the restriction through an upstream port and the second pressure sensor may be coupled to the passageway downstream of the restriction through a downstream port. The method may also include independently measuring the quantity of fuel flowing through the passageway based on measurements of a third pressure sensor coupled to the upstream port through a first branch port, and a fourth pressure sensor coupled to the downstream port through a second branch port.

In yet another aspect, a fuel control system for a gas turbine engine is disclosed. The control system may include a conduit configured to direct a fuel to a combustor of the gas turbine engine, and a flow valve including a flow restriction. The flow valve may include a first pressure sensor configured to measure a pressure upstream of the restriction, a second pressure sensor configured to measure a pressure downstream of the restriction, and an electronics module configured to measure a quantity of fuel flowing in the conduit based on the measurements of the first and the second pressure sensor. The control system may also include a third pressure sensor configured to measure the pressure upstream of the restriction independent of the first pressure sensor, and a fourth pressure sensor configured to measure the pressure downstream of the restriction independent of the second pressure sensor. The control system may be configured to receive a value indicative of the measured quantity of fuel from the electronics system, and independently determine the quantity of the fuel flowing in the conduit based on the measurements of the third and the fourth pressure sensor.

### BRIEF DESCRIPTION OF THE DRAWINGS

FIG. 1 is a cutaway-view illustration of an exemplary disclosed gas turbine engine;

FIG. 2 is a schematic illustration of an exemplary control system of the gas turbine engine of FIG. 1;

FIG. 3A is a schematic illustration of an exemplary fuel valve of the gas turbine engine of FIG. 1;

FIG. 3B is a perspective view of an exemplary fuel valve of the gas turbine engine of FIG. 1; and

FIG. 4 is a flow chart illustrating an exemplary operation of the gas turbine engine of FIG. 1.

### DETAILED DESCRIPTION

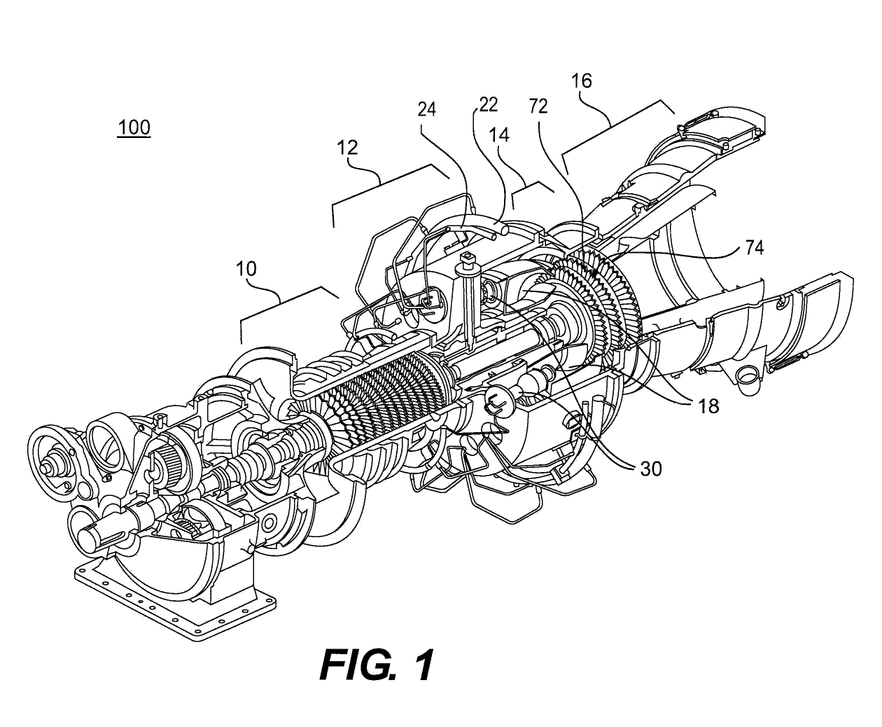

FIG. 1 illustrates an exemplary gas turbine engine 100. Gas turbine engine 100 may have, among other systems, a compressor system 10, a combustor system 12, a turbine system 14, and an exhaust system 16. In general, compressor system 10 compresses air to a high pressure and directs the compressed air to combustor system 12. A gaseous fuel and a liquid fuel are directed to the combustor system 12 through a gaseous fuel pipe 22 and a liquid fuel pipe 24, respectively. One or more of these fuels are mixed with the compressed air in fuel injectors 30 and combusted in a combustor 18 of the combustor system 12. Since both a liquid fuel and a gaseous fuel may be selectively directed to combustor 18 through fuel injectors 30, gas turbine engine 100 is commonly called a dual fuel gas turbine engine, and fuel injectors 30 are commonly called dual fuel injectors. Combustion of the fuel in combustor 18 produces combustion gases at a high pressure, temperature, and velocity. These combustion gases rotate rotors of the turbine system 14 to generate power. The spent combustion gases are then exhausted to the atmosphere through exhaust section 16.

Various types of gaseous and liquid fuels may be directed into combustor 18 through fuel injectors 30. The gaseous fuel may include, for example, natural gas, landfill gas, bio-gas, syngas, etc. The liquid fuels may include diesel, kerosene, gasoline, or any other type of liquid fuel. In some applications, the gas turbine engine 100 may be operated primarily using a fuel that is cheaply available at the location where the gas turbine engine 100 is operating. For example, in an oil field with an abundant supply of natural gas, the gas turbine engine 100 may operate primarily using natural gas. In such applications, liquid fuel may be reserved for engine operating conditions where a liquid fuel may be more desirable. For instance, a liquid fuel may be directed to gas turbine engine 100 during startup and when combustion instabilities are detected in the combustor 18. After the gas turbine engine 100 reaches a stable operating condition, the liquid fuel supply to the turbine engine 100 may be turned off, and the gaseous fuel supply turned on.

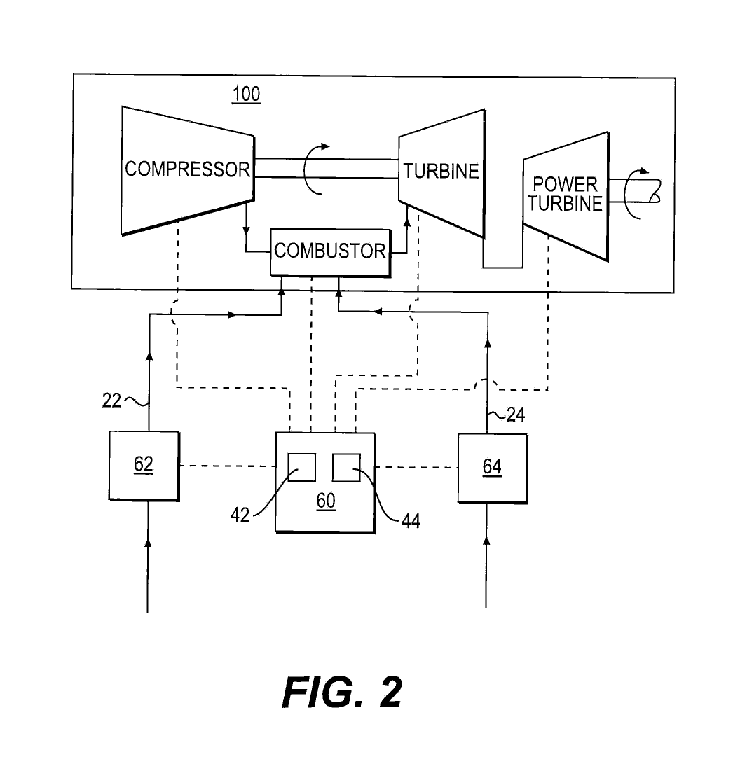

FIG. 2 is a schematic illustration of a fuel flow system of gas turbine engine 100. The fuel flow system may include a control system 60 configured to control the fuel flow to the gas turbine engine 100. For example, based on power requirements, control system 60 may control the amount of fuel directed to the gas turbine engine 100 through gaseous fuel pipe 22 and liquid fuel pipe 24 to produce the required power in a stable manner. Control system 60 may include a microprocessor 42, storage memory 44, and/or other electronic components (not shown) that operate to control the operation of gas turbine engine 100. In addition to functions normally performed by control systems known in the art, control system 60 may also control the type and quantity of fuel directed to the gas turbine engine 100 based on operating parameters. Gaseous fuel pipe 22 and/or liquid fuel pipe 24 may be fluidly coupled to sensors and measurement devices adapted to measure parameters related to fuel flow. These measurement devices may include, among others, a fuel valve 62 that measures the amount of gaseous fuel directed to turbine engine 100 through gaseous fuel pipe 22. In some embodiments, liquid fuel pipe 24 may also be fluidly coupled to a fuel valve 64 adapted to measure the amount of liquid fuel directed to turbine engine 100. In some embodiments, fuel valves 62 and 64 may be a flow control device with embedded flow measurement capability.

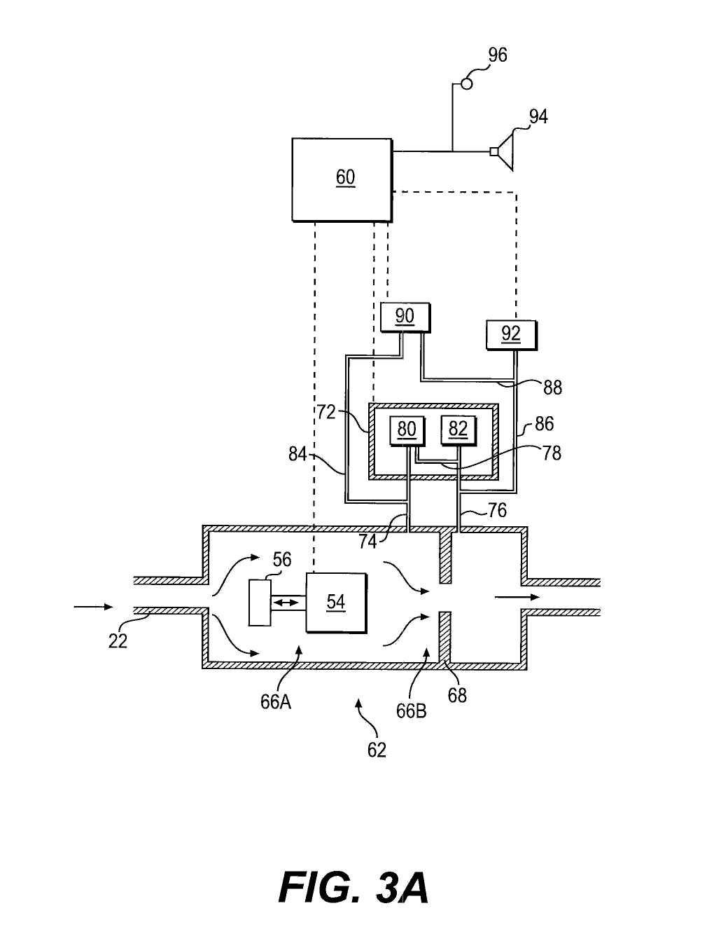

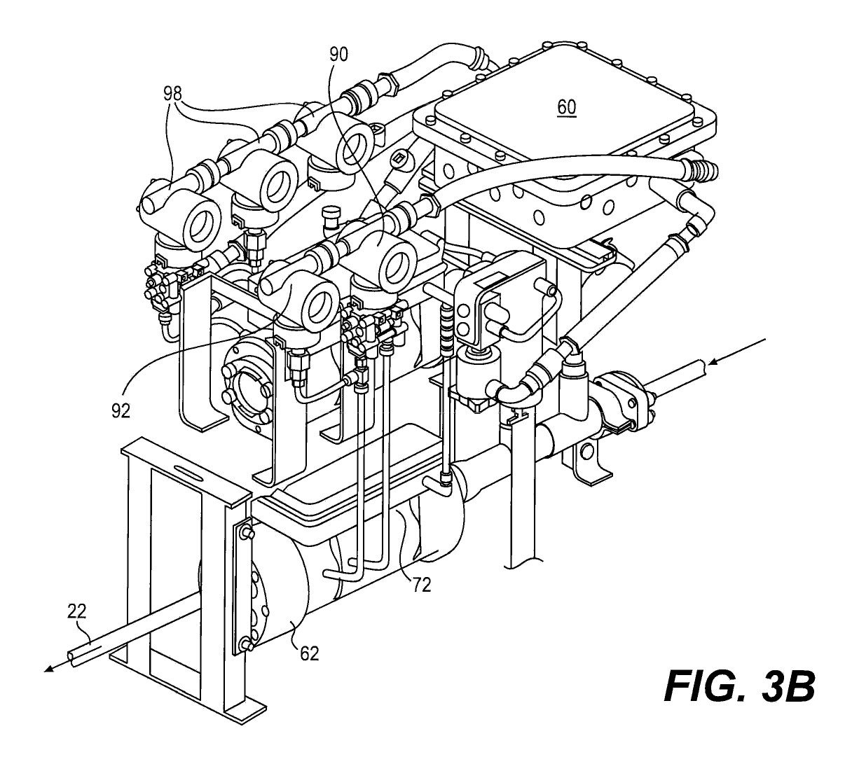

Fuel valve 62 may include any type of measurement device configured to measure one or more parameters indicative of the quantity of fuel flowing through the gaseous fuel pipe 22. For example, fuel valve 62 may include an electronic fuel metering valve that both measures and controls the amount of fuel flowing through the fuel valve 62. In other embodiments, these two functions may be performed by separate devices. FIGS. 3A and 3B illustrate views of an exemplary fuel valve 62 with embedded flow measurement capability coupled to gaseous fuel pipe 22. FIG. 3A illustrates a schematic view and FIG. 3B illustrates a perspective view of the fuel valve 62. In the discussion that follows, reference will be made to both FIGS. 3A and 3B. Fuel valve 62 may include a flow metering section 66a and a flow measurement section 66b. Flow metering section 66a may include an actuator 54 that activates a poppet valve 56 to control the amount of fuel entering the fuel valve 62 in response to signals from control system 60. For instance, in response to instructions from control system 60, actuator 54 may move the poppet valve 56 to increase or decrease the flow of fuel directed to the gas turbine engine 100 through the gaseous fuel pipe 22.

Flow measurement section 66b may include a flow restriction, such as an orifice plate 68, adapted to measure the quantity (for example, flow rate) of fuel passing therethrough. Orifice plate 68 is a plate with a hole in the middle, positioned in the path of fuel flowing through fuel valve 62. When the fuel reaches the orifice plate 68, the fuel stream converges to pass through the hole. As the fuel converges, its velocity and pressure changes. Although the flow restriction is described as being an orifice plate 68, this is only exemplary. In general, any type of flow restriction used to measure flow may be used in fuel valve 62. As is known in the art, by measuring the difference in fluid pressure upstream and downstream of the orifice plate, the volumetric and mass flow rates of the fuel can be obtained using Bernoulli's equation. Fuel valve 62 may include an electronics module 72 that measures the difference in pressure upstream and downstream of the orifice plate 68 and computes the flow rate (or another parameter indicative of quantity) of fuel flowing through the fuel valve 62. The electronics module 72 may include sensors, such as pressure sensors, configured to measure the pressure difference across the orifice plate 68. These sensors may include an upstream pressure sensor 80 fluidly coupled to an upstream region of the orifice plate 68 through an upstream port 74, and a downstream pressure sensor 82 fluidly coupled to a downstream region of the orifice plate 68 through a downstream port 76.

In some embodiments, the upstream pressure sensor 80 and/or the downstream pressure sensor 82 may be a differential pressure sensor. In embodiments where the upstream pressure sensor 80 is a differential pressure sensor, in addition to the upstream port 74 fluidly coupling the pressure sensor 80 to the upstream region of orifice plate 68, a branch conduit 78 may fluidly couple the downstream port 76 to the pressure sensor 80. Similarly, in embodiments where the downstream pressure sensor 82 is a differential pressure sensor, the branch conduit 78 may fluidly couple the upstream port 74 to the downstream pressure sensor 82. Electronics module 72 may be an integral part of the fuel valve 62 and may provide the embedded flow measurement capability of fuel valve 62. In some embodiments, as illustrated in FIG. 3, the integral electronics module 72 may be external to, and attached to, the fuel valve 62. However, it is also contemplated that in some embodiments, the electronics module 72 may be internal to the fuel valve 62. The electronics module 72 may also include other sensors 98, such as temperature sensors, configured to measure other parameters of the fuel flowing through the fuel valve 62. Based on the measurements of the upstream pressure sensor 80 and the downstream pressure sensor 82 (and in some embodiments, other sensors of electronics module 72), the flow rate of fuel flowing through the fuel valve 62 may be determined by electronics module 72, and communicated to control system 60.

Based on the operating conditions and the required power output of gas turbine engine 100, the control system 60 may activate actuator 54 to control the quantity of fuel directed to the gas turbine engine 100. Measurement errors associated with one of more of the sensors of electronic module 72 may introduce errors in the fuel flow quantity determined by the electronics module 72. Such flow measurement errors may lead to improper quantity of fuel being directed to the combustor, and thus lead to inefficient operation of gas turbine engine 100. To minimize the likelihood of measurement errors from affecting the efficiency of the turbine engine 100, the fuel valve 62 may be provided with redundant flow measurement capabilities. To provide redundant flow measurement capabilities, secondary pressure sensors 90 and 92 may be fluidly coupled to the upstream and downstream sections of orifice plate 68. To ensure that fuel pressure of the same region of the fuel valve 62 is being measured by both the upstream pressure sensor 80 and the secondary pressure sensor 90, a branch conduit 84 may fluidly couple the secondary pressure sensor 90 to the upstream port 74. Similarly, to ensure that fuel pressure of the same region of the fuel valve 62 is measured by both the downstream pressure sensor 82 and the secondary pressure sensor 92, a branch conduit 86 may fluidly couple the secondary pressure sensor 92 to the downstream port 76. It is also contemplated that, in some embodiments, instead of connecting to the upstream and downstream ports 74, 76, the branch conduits 84, 86 may connect directly to the upstream and downstream sections of the orifice plate 68. In such embodiments, the upstream port 74 and the branch conduit 84 may be coupled to the upstream section such that both the upstream pressure sensor 80 and the secondary pressure sensor 90 are exposed to substantially the same fuel pressure. Similarly, the downstream port 76 and the branch conduit 86 may be coupled to the downstream section such that both the downstream pressure sensor 82 and the secondary pressure sensor 92 are exposed to substantially the same fuel pressure. In some embodiments, one or both of the secondary pressure sensors 90, 92 may be a differential pressure sensor. In embodiments where secondary pressure sensor 90 is a differential pressure sensor, a branch conduit 88 may fluidly couple branch conduit 86 to secondary pressure sensor 90. In some embodiments, in addition to secondary pressure sensors 90, 92, other secondary sensors 98 may also be provided for redundant measurement capability of other parameters of the fuel flowing through fuel valve 62.

The signals from the secondary pressure sensors 90, 92 may be directed to control system 60. The control system 60 may use these received signals to determine the flow rate of fuel through fuel valve 62, independent of the flow rate communicated to the control system 60 by electronics module 72. The ability of the control system 60 to independently measure the flow rate enables the flow rate to be measured accurately even when the sensors of the electronic module 72 are non operational or faulty. Thus the secondary pressure sensors 90, 92 provide redundant flow measurement capabilities to fuel valve 62. If the control system 60 detects a difference in the determined and the received values of flow rate (referred to herein as “error”), the control system 60 may take corrective action.

The corrective action taken by the control system 60 may depend upon the application. For instance, in some embodiments, the control system 60 may shut down the gas turbine engine 100 if the error exceeds a threshold value. In some embodiments, the control system 60 may alert an operator (for example, using an alarm 94 and/or an indicator light 96) in response to an error exceeding a threshold value. In embodiments using a dual fuel gas turbine engine 100, the control system 60 may switch the fuel supply to the gas turbine engine 100 in response to an error in fuel flow measurement. For instance, if an error exceeding a threshold value in the flow rate of gaseous fuel is detected, the control system 60 may turn off the supply of gaseous fuel to the turbine engine 100 and operate the turbine engine 100 using liquid fuel until the error is fixed. It should be noted that the corrective actions described above are only exemplary, and in general, any type of corrective action may be carried out by the control system 60 in response to a detected error.

In some embodiments, the liquid fuel supply to the gas turbine engine 100 may also be provided with redundant flow measurement capability in a manner described above. It should be noted that although a dual fuel gas turbine engine 100 is described herein, this is only exemplary. That is, in some embodiments, gas turbine engine 100 may be a single fuel gas turbine engine. It should further be noted that, although the novel aspects of the current disclosure are described with reference to a gas turbine engine, this is only exemplary. In general, the disclosed flow control system may be applied to any application. For instance, the flow control system of the current disclosure may be applied to control the fuel flow to another engine, such as, for example, an internal combustion engine, or to measure the flow of a fluid through a pipeline.

### INDUSTRIAL APPLICABILITY

The disclosed fuel valve may be applicable to any gas turbine engine in which reliable fuel flow is desired. The disclosed fuel valve may be used to provide redundant fuel flow measurement capability to any gas turbine engine regardless of the type of fuels used. The operation of gas turbine engine 100 will now be explained.

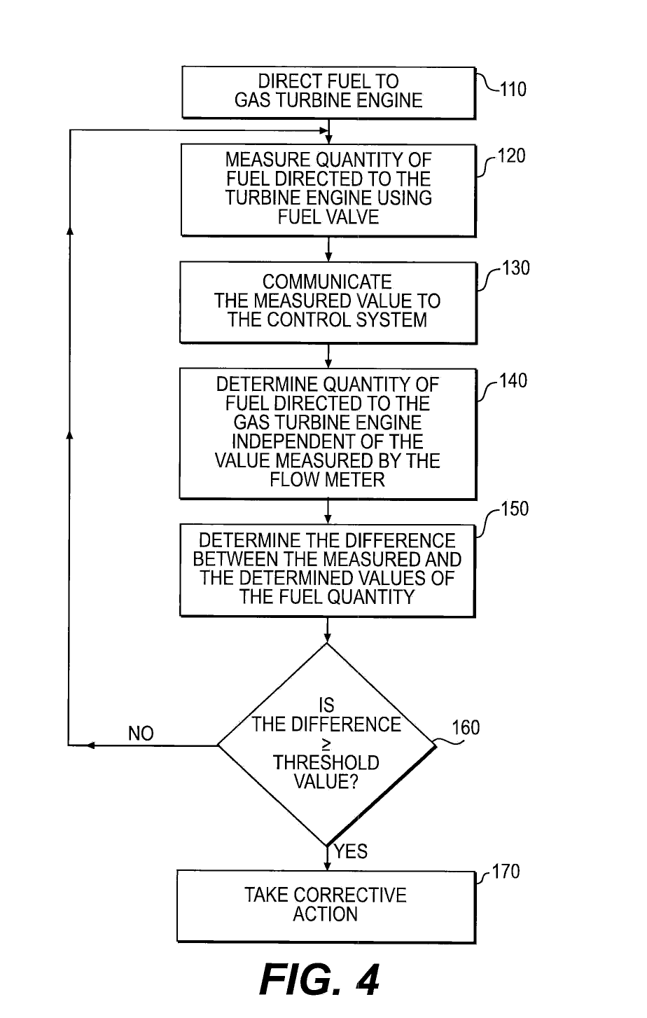

FIG. 4 is a flow chart that illustrates an exemplary operation of the gas turbine engine 100. In the exemplary application, the gas turbine engine 100 is operated using a gaseous fuel directed thereto, through gaseous fuel pipe 22 (step 110). As the gaseous fuel flows through the gaseous fuel pipe 22, the fuel valve 62 measures the quantity of fuel (such as, mass flow rate) passing through the gaseous fuel pipe 22 (step 120). The value of the measured quantity of fuel is communicated from the fuel valve 62 to the control system 60 (step 130). The control system 60 also determines the quantity of fuel passing through the gaseous fuel pipe 22 independently of the value measured by the fuel valve 62, using pressure data from the secondary pressure sensors 90 and 92 (step 140). The control system 60 then determines the difference between the measured and the determined values of the quantity of fuel directed to the gas turbine engine 100 (step 150). If the difference between these values is greater than or equal to a threshold (step 160), the control system 60 takes corrective action (step 170). If the difference between the received and computed values is less than the threshold, the control system continues to monitor the flow through the fuel valve 62. Incorporating a redundant fuel flow measurement capability to the fuel valve 62 allows the fuel flow to turbine engine 100 to be measured in a reliable manner even when the flow meter is non operational or faulty.

It will be apparent to those skilled in the art that various modifications and variations can be made to the disclosed fuel valve. Other embodiments will be apparent to those skilled in the art from consideration of the specification and practice of the disclosed fuel valve. It is intended that the specification and examples be considered as exemplary only, with a true scope being indicated by the following claims and their equivalents.

What is claimed is:

1. A fuel valve for a gas turbine engine, comprising:
a passageway configured to direct a fuel to the engine;
a flow restriction positioned in the passageway;
a first pressure sensor coupled to the passageway upstream of the restriction through an upstream port and a second pressure sensor coupled to the passageway downstream of the restriction through a downstream port; and
a third pressure sensor coupled to the upstream port through a first branch port and a fourth pressure sensor coupled to the downstream port through a second branch port.

2. The fuel valve of claim 1, wherein the flow restriction is an orifice.

3. The fuel valve of claim 1, wherein the first and the second pressure sensors are embedded in the fuel valve.

4. The fuel valve of claim 1, further including a flow metering section positioned in the passageway, the flow metering section being configured to vary the amount of fuel flowing through the passageway.

5. The fuel valve of claim 4, wherein the flow metering section includes an actuator driven valve.

6. The fuel valve of claim 1, wherein one of the first or the second pressure sensor is a differential pressure sensor.

7. The fuel valve of claim 6, wherein one of the third or the fourth pressure sensor is a differential pressure sensor.

8. The fuel valve of claim 1, wherein the first and the second pressure sensors are together configured to measure a quantity of fuel flow through the passageway.

9. The fuel valve of claim 8, wherein the third and fourth pressure sensors are together configured to measure the quantity of fuel flow through the passageway independent of the measurements of the first and second pressure sensors.

10. The fuel valve of claim 1, further including a temperature sensor coupled to the passageway.

11. A method of measuring a quantity of fuel flowing to a gas turbine engine, comprising:
directing the fuel to the engine through a flow restriction positioned in a passageway;
measuring the quantity of fuel flowing through the passageway based on measurements of a first pressure sensor coupled to the passageway upstream of the restriction through an upstream port and a second pressure sensor coupled to the passageway downstream of the restriction through a downstream port; and
independently measuring the quantity of fuel flowing through the passageway based on measurements of a third pressure sensor coupled to the upstream port through a first branch port and a fourth pressure sensor coupled to the downstream port through a second branch port.

12. The method of claim 11, further including determining a difference between the quantity of fuel measured based on the first and second pressure sensors and the quantity of fuel measured based on the third and fourth pressure sensors and taking corrective action if the difference exceeds a threshold value.

13. The method of claim 12, wherein the corrective action include shutting down the engine.

14. The method of claim 12, wherein the corrective action includes notifying an operator.

15. The method of claim 12, wherein the flow restriction includes an orifice.

16. A fuel control system for a gas turbine engine, comprising:
a conduit configured to direct a fuel to a combustor of the gas turbine engine;
a fuel valve including a flow restriction, the fuel valve further including:
a first pressure sensor configured to measure a pressure upstream of the restriction;
a second pressure sensor configured to measure a pressure downstream of the restriction; and
an electronics module configured to measure a quantity of fuel flowing in the conduit based on the measurements of the first and the second pressure sensor;
a third pressure sensor configured to measure the pressure upstream of the restriction independent of the first pressure sensor; and
a fourth pressure sensor configured to measure the pressure downstream of the restriction independent of the second pressure sensor, wherein the control system is configured to receive a value indicative of the measured quantity of fuel from the electronics module, and independently determine the quantity of the fuel flowing in the conduit based on the measurements of the third and the fourth pressure sensor.

17. The system of claim 16, wherein the control system is further configured to determine a difference between the received and the determined quantity and take corrective action based on the difference.

18. The system of claim 17, wherein the control system is configured to shut down the gas turbine engine if the difference exceeds a threshold value.

19. The system of claim 17, wherein the control system is configured to alert an operator if the difference exceeds a threshold value.

20. The system of claim 16, further including an upstream duct that fluidly connects a region upstream of the restriction to the first pressure sensor, a downstream duct that fluidly connects a region downstream of the restriction to the second pressure sensor, a first branch duct that fluidly connects the upstream duct to the third pressure sensor, and a second branch duct that fluidly connects the downstream duct to the fourth pressure sensor.
